(19) United States
(12) Patent Application Publication
(10) Pub. No.: US 2006/0007165 A1
(43) Pub. Date: Jan. 12, 2006

(54) INPUT-SENSOR-INTERGRATED LIQUID CRYSTAL DISPLAY PANEL

(76) Inventors: Kei-Hsiung YANG, Tao-Yuan Hsien (TW); Wei-Chou CHEN, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/711,213

(22) Filed: Sep. 1, 2004

(30) Foreign Application Priority Data
Jun. 25, 2004 (TW) 093118608

(51) Int. Cl. G09G 5/00

(52) U.S. Cl. 345/173

(57) ABSTRACT

An input-sensor-integrated liquid crystal display panel has a first substrate, a second substrate, and a liquid crystal layer. The first substrate has at least one pixel controlling circuit, and the second substrate has a touch-detecting circuit. A color filter layer is formed between the first and second substrates, and the liquid crystal layer is filled in space formed by the first and second substrates.

### BACKGROUND OF INVENTION

1. Field of the Invention

The present invention relates to a liquid crystal display panel, and more particularly to a liquid crystal display having integrated input sensor.

2. Description of the Prior Art

Nowadays, liquid crystal displays with touch panel have been widely used as a medium of data communication in each scope of consuming electric products, such as personal digital assistant (PDA), mobile phone, notebook and tablet PC and other portable electric products. In addition, as a result of that the present design of electric products tends to be light, thin, and tiny, there is not enough space for installing keyboard, mouse and other traditional input components. The requirement of tablet PC with human-friendly design has further pushed touch panel to become one of the most important computer components. A touch panel not only satisfies the requirement of performing multi-layer menu design, but also has the functions of being a keyboard or a mouse. More practically, the functions of inputting and outputting signals are integrated within the same medium (screen). These advantages make the touch panel be superior to other traditional input components.

FIG. 1 is a schematic diagram of a traditional touch panel for a display device. The traditional touch panel 100 is consisted of a liquid crystal display panel and a detecting panel. The liquid crystal display panel includes a bottom substrate 102, an upper substrate 104, a liquid crystal layer 110, color filters 108 and polarizers 112 and 114 disposed on the outside surface of the bottom substrate 102 and the upper substrate 104 separately. The pixel controlling circuit 118 is to control the liquid crystal molecular of the liquid crystal layer 110 with an angle so that the color filter 108 can display different color and brightness effect in accordance with light permeability. The detecting panel includes a glass substrate 106 and a detecting layer 116. The detecting layer 116 has a touch-detecting circuit detecting contacts, touches and motions from fingers or other pointers.

The traditional touch panel 100 made by stacking up a liquid crystal display panel and a detecting panel has the function of detecting touch signals. However, the stake of the two panels reduces optical quality, for instance, the decrease of light-permeability or the increase of reflection rate. Besides, the traditional touch panel might not be wildly acceptable due to the heavy weight.

### SUMMARY OF INVENTION

It is therefore a primary objective of the claimed invention to provide a liquid crystal display panel having integrated input sensor to solve the aforementioned problem. In the invention, a single liquid display panel can provide the functions of displaying images and detecting touch signals.

In accordance with the claim, an input-sensor-integrated liquid crystal display is disclosed. The liquid crystal display comprises a first substrate, a second substrate, a color filter and a liquid crystal layer. The first substrate has at least one pixel controlling circuit, and the second substrate has a touch-detecting circuit. The liquid crystal layer is filled in the space formed by the first substrate and the second substrate.

The invention may be understood by reference to the following description of an illustrative embodiment. However, it should be mentioned that the preferred embodiment is only for reference and description instead of limiting the present invention.

### BRIEF DESCRIPTION OF DRAWINGS

FIG. 1 is schematic diagram of a traditional touch panel for a display device according to prior art.

FIG. 2 and FIG. 3 are schematic diagrams of the first preferred embodiment according to the present invention.

FIG. 4 and FIG. 5 are schematic diagrams of input-sensor-integrated liquid crystal display panels according to the present invention.

FIG. 6 is a schematic diagram of the second preferred embodiment according to the present invention.

FIG. 7 is a schematic diagram of the third preferred embodiment according to the present invention.

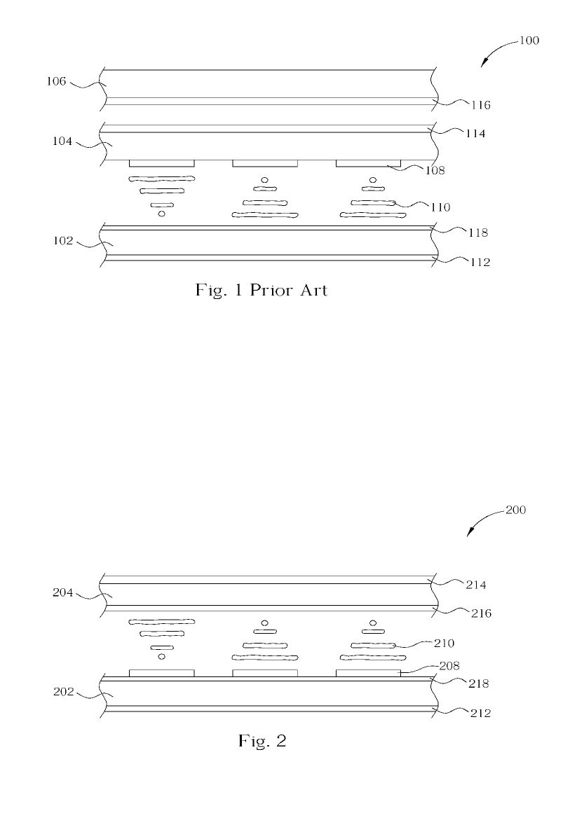

### DETAILED DESCRIPTION

Please refer to FIG. 2. FIG. 2 is a schematic diagram of a preferred embodiment. A liquid crystal display panel 200 includes a bottom substrate 202, a top substrate 204, and a liquid crystal layer 210. The top substrate 204 is positioned on top of the bottom substrate in parallel. The liquid crystal layer 210 is filled between the top substrate 204 and the bottom substrate 202. The bottom substrate 202 has a pixel controlling circuit 218 for controlling pixels on and off. The color filter is positioned above the pixel controlling circuit 218 for filtering lights through the liquid crystal display panel 200 and ensuring that each pixel performs proper color. The pixel controlling circuit 218 and color filter 208 are fabricated on the same substrate by the color filter on array process (COA) technique. Therefore, more surface space is reserved for other application on the top substrate 204.

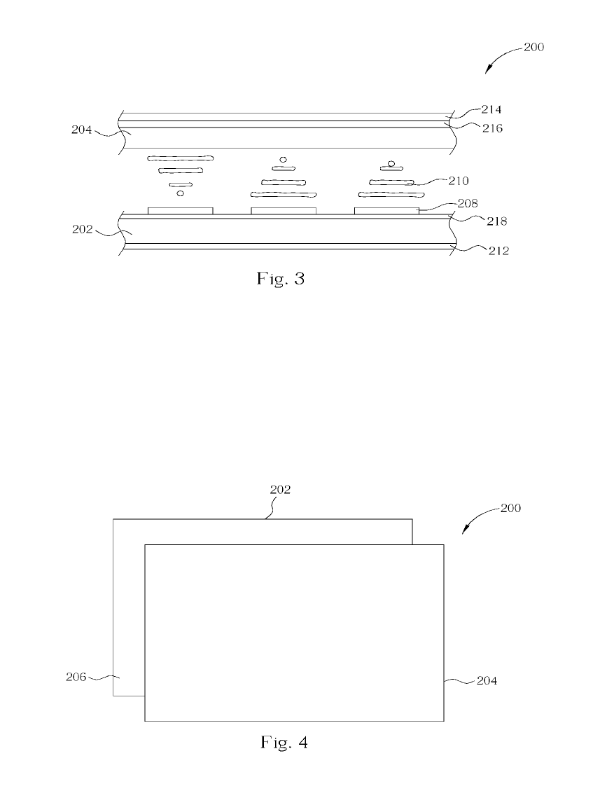

In the present embodiment, the top substrate 204 has a detecting layer 216 with touch-detecting circuit that can detect touches and motions of fingers or touch pointers. The touch-detecting circuit is a resistance detecting circuit, capacitance detecting circuit, sound wave detecting circuit, or optical detecting circuit. In addition, the liquid crystal display 200 further comprises polarizer 212 and polarizer 214 positioned on the outer surfaces of the top substrate 202 and the bottom substrate 204. Apart from positioning the detecting layer 216 on the inner surface of the top substrate 204 facing the bottom substrate 202, as shown in FIG. 2, the detecting layer 216 is positioned on the outer surface of the top substrate 204 not facing the bottom surface 202, as shown in FIG. 3. In FIG. 3 the detecting layer 216 is positioned on the outer surface of the top substrate 204 not facing the bottom substrate 202, i.e. the detecting layer 216 is between the top substrate 214 and the polarizer 214.

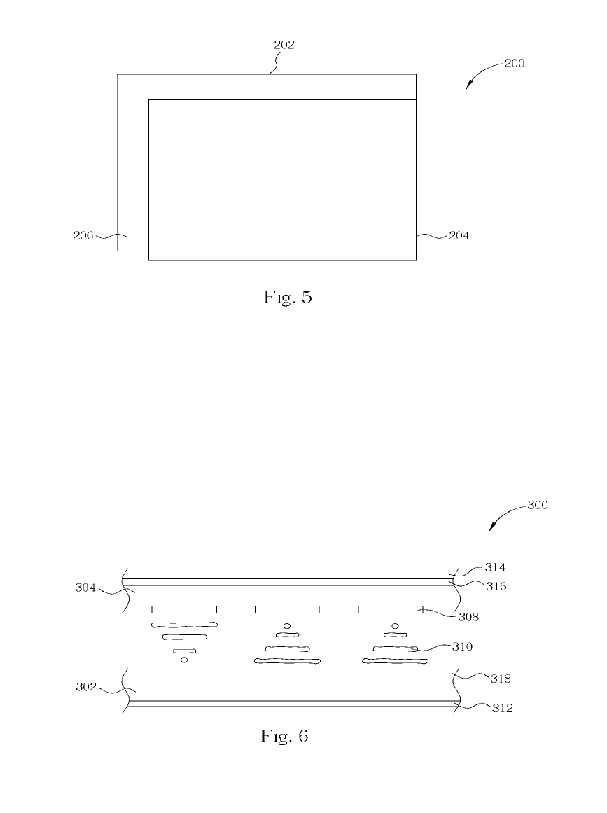

In accordance with the bottom substrate 202 having pixel controlling circuit 218 and the top substrate 204 having detecting layer (tough-detecting circuit) 216, the bottom substrate 202 and the top substrate 204 have to have signal contacts to transmit every kind of pixel controlling signals and touch-detecting signals. To achieve the demand, the top substrate 204 is not designed to coincide with the bottom substrate 202 completely for setting signal connecting contacts. For instance, the top substrate 204 has at least one protrusion 206 jutting out the bottom substrate 202 and the bottom substrate 202 has at least one protrusion jutting out the top substrate 204. Consequently, the structure is constructed as shown in the FIG. 4 and FIG. 5. In the FIG. 4 and FIG. 5, the top substrate 202 and the bottom substrate 204 have at least one edge jutting out another substrate for installing signal connecting contacts and connecting to controlling or detecting circuit outside.

Please refer to the FIG. 6. FIG. 6 is a schematic diagram of the second illustrative embodiment. The liquid crystal display panel 300 includes a bottom substrate 302, a top substrate 304 and a liquid crystal layer 310. A pixel controlling circuit is fabricated on the bottom substrate 302, a color filter 308 is fabricated on the inner surface of the top substrate 304 facing the bottom substrate 302, and a detecting layer 316 is disposed on the outer surface of the top substrate 304 not facing the bottom substrate 302. The liquid crystal layer 310 is filled between the top substrate 304 and the bottom substrate 302. The detecting layer 316 has a touch-detecting circuit detecting touch and motion signals from fingers or touch pointers. The touch-detecting circuit is a resistance detecting circuit, capacitance detecting circuit, sound wave detecting circuit, or optical detecting circuit. The liquid crystal display further comprises polarizer 314 and polarizer 312 positioned on the outer surfaces of the bottom substrate 302 and the top substrate 304 separately.

In the present embodiment, the detecting layer 316 and the color filter 308 is fabricated on the two sides of the top substrate 304 to make the top substrate 304 have functions of displaying images and detecting signals. The bottom substrate 302 and the top substrate 304 are designed to have at least one edge jutting out the edge of the other substrate for setting signal connecting contacts and connecting controlling circuit or detecting circuit outside.

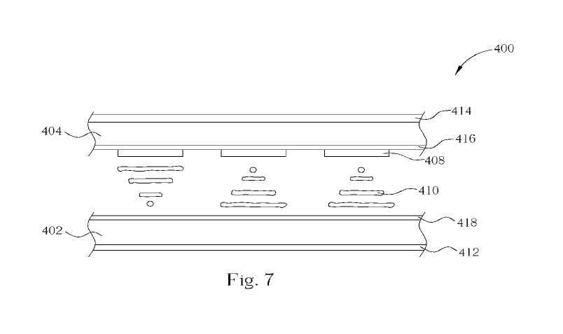

Please refer to FIG. 7. FIG. 7 is a schematic diagram of the third preferred embodiment. The structure of the liquid crystal display panel 400 is similar to the aforementioned liquid crystal display panel 300, wherein the detecting layer 416 and the color filter 408 are fabricated on the top substrate 404. The difference is that the detecting layer 416 and the color filter 408 are fabricated on the same side of the top substrate 404.

As shown in FIG. 7, the liquid crystal display panel 400 includes a bottom substrate 402, a top substrate 404, and a liquid crystal layer 410. A pixel controlling circuit 418 is disposed on the bottom substrate 402. A color filter 408 and a detecting layer 416 are fabricated on the top substrate 404. The detecting layer 416 has a touch-detecting circuit detecting touches and motions of fingers or other pointers. The touch-detecting circuit is a resistance detecting circuit, capacitance detecting circuit, sound wave detecting circuit, or optical detecting circuit. The color filter 408 is positioned on the surface of the detecting layer 416 and the liquid crystal layer 410 is between the top substrate 404 and the bottom substrate 402. In addition, the liquid crystal display panel further comprises polarizer 412 and polarizer 414 positioned on the outer surfaces of the bottom substrate 402 and the top substrate 404 separately.

For a convenient design of signal connecting contacts, at least one protrusion is made at the bottom substrate 402 and the top substrate 404 for setting signal connecting contacts and connecting controlling circuit or detecting circuit outside.

Compared with the traditional touch panel for a display device, the present input-sensor-integrated liquid crystal display panel has the advantage of integrating a touch-controlling circuit into liquid crystal display panel. In another words, the liquid crystal display panel not only displays images but also detects touch signals. Therefore, the prior art problems of the decrease of optical quality and the heavy product weight can be solved in accordance with the invention.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An input-sensor-integrated liquid crystal display panel, comprising:
a first substrate having at least one pixel controlling circuit;
a second substrate having a touch-detecting circuit and being positioned on top of the first substrate; and
a liquid crystal layer filled between the space formed by the first substrate and the second substrate.

2. The input-sensor-integrated liquid crystal display panel of claim 1 wherein the first substrate further comprises a color filter.

3. The input-sensor-integrated liquid crystal display panel of claim 1 wherein the second substrate further comprises a color filter.

4. The input-sensor-integrated liquid crystal display panel of claim 3 wherein the color filter is formed on the touch-detecting circuit.

5. The input-sensor-integrated liquid crystal display panel of claim 3 wherein the color filter and the touch-detecting circuit are formed on different sides of the second substrate.

6. The input-sensor-integrated liquid crystal display panel of claim 1 wherein the touch-detecting circuit is positioned on an inner side of the second substrate facing the first substrate.

7. The input-sensor-integrated liquid crystal display panel of claim 1 wherein the touch-detecting circuit is positioned on an outer side of the of the second substrate.

8. The input-sensor-integrated liquid crystal display panel of claim 1 wherein the first substrate dis-coincide with the second substrate and has at least one protrusion.

9. The input-sensor-integrated liquid crystal display panel of claim 8 wherein the protrusion includes a plurality of signal connecting contacts.

10. The input-sensor-integrated liquid crystal display panel of claim 1 further comprising a polarizer.

11. The input-sensor-integrated liquid crystal display panel of claim 10 wherein the touch-detecting circuit is positioned between the second substrate and the polarizer.

12. The input-sensor-integrated liquid crystal display panel of claim 1 wherein the touch-detecting circuit is a resistance detecting circuit, capacitance detecting circuit, sound wave detecting circuit, or optical detecting circuit.
